(19) United States
(12) Patent Application Publication
(10) Pub. No.: US 2025/0264906 A1
(43) Pub. Date: Aug. 21, 2025

(54) CLOCK ELEMENT DESIGN SYSTEM AND METHOD USING A NO-CODE APPROACH

(71) Applicant: ITDA SEMICONDUCTOR CO., LTD., Hwaseong-si (KR)

(72) Inventors: Ingyu KIM, Hwaseong-si (KR); Hoyeon JEON, Seongnam-si (KR); Ahchan KIM, Hwaseong-si (KR)

(73) Assignee: ITDA SEMICONDUCTOR CO., LTD., Hwaseong-si (KR)

(21) Appl. No.: 19/054,023

(22) Filed: Feb. 14, 2025

(30) Foreign Application Priority Data
Feb. 15, 2024 (KR) 10-2024-0021426

(51) Int. Cl. G06F 1/04

(52) U.S. Cl. CPC G06F 1/04

(57) ABSTRACT

Disclosed are a clock element no-code design system including: a memory configured to store at least one instruction; a clock component storage configured to store clock component information defining an address and field values of a register of a clock instance generated based on a clock component; a hardware code logic storage configured to store a hardware code logic for generating hardware code based on a designed clock instance; and at least one processor configured to execute the at least one instruction stored in the memory, wherein the at least one instruction includes instructions to: design a new clock instance by setting field values of a register defining a function of the new clock instance based on previously generated clock instance information and the clock component information, and generate hardware code by generating a clock module and a register module corresponding to the clock module based on the field values of the register of the designed new clock instance and the hardware code logic, and combining the clock module and the register module.

### CROSS-REFERENCE TO RELATED APPLICATION

This application claims the benefit of and priority to Korean Patent Applications No. 10-2024-0021426, filed on Feb. 15, 2024, which is incorporated by reference herein in its entirety.

### TECHNICAL FIELD

The present disclosure relates to clock element no-code design system and method, and more particularly, to a system and a method for designing individual clock elements constituting a clock management unit of a system-on-chip using a no-code approach.

### RELATED ART

A system-on-chip (SoC) refers to a technology for integrating various function blocks such as a central processing unit (CPU), memory, interface, digital signal processing circuits, and analog signal processing circuits into a single semiconductor integrated circuit to implement a computer system or other electronic systems, or an integrated circuit (IC) integrated according to the technology. The SoC is evolving into a more complex system that includes various function blocks such as processors, multimedia, graphics, interfaces, and security features.

In general, power and clock design is important for a system-on-chip. A power and clock design process for a system-on-chip may include a power and clock diagram drawing stage, a Verilog coding and scripting stage, a first documentation stage, a Unified Power Format (UPF) and Standard Design Constraint (SDC) file generation stage, an implementation layout design stage, a second documentation stage, a design-for-testability (DFT) controller insertion stage, a hardware system analysis stage, and a software optimization stage.

The power and clock diagram drawing stage is the stage in which a power and clock structure is visually represented and drawn as a block diagram to illustrate the power domain and clock tree. In the power and clock diagram drawing stage, clock elements and their link relationships are simply represented in a diagram. The Verilog coding and scripting stage is the stage in which the register transfer level (RTL) design of hardware is performed by writing Verilog code and scripts used to define and implement the functions of an SoC. That is, a developer manually generates register transfer level (RTL) code based on the results of the power and clock diagram drawing stage.

The first documentation stage is the stage for documenting the design intent and structure at the beginning of a project, in which various types of documents, such as requirement specifications, architecture designs, and power and clock diagrams required by stakeholders such as the verification team and the software development team, are created.

The UPF and SDC file generation stage is the stage in which Unified Power Format (UPF) and Standard Design Constraint (SDC) files are generated to control power management and timing constraints, and the necessary inputs for hardware synthesis are produced.

The implementation layout design stage is the stage in which the actual layout of an SoC chip is designed and placed at the gate level. The second documentation stage is the stage in which various documents are updated and refined to reflect changes in the design and implementation. The DFT controller insertion stage is the stage in which a DFT controller and logic circuits for testing and debugging are designed and integrated into an SoC. The hardware system analysis stage is the stage in which the operation of the hardware is verified and analyzed through simulation and validation to ensure the accuracy and efficiency of the design. The software optimization stage is the stage in which software performance is enhanced by profiling and optimizing the software code running on the SoC.

In each stage of an SoC design process, various stakeholders independently perform the work related to their respective stages, and the information required at each stage may differ. In other words, the information required for the first half of the process may differ from that required for the second half. For this reason, the initial design work produced by workers in the first half of a project may reveal issues during simulation and verification in the second half, requiring the first half of the work to be repeated to resolve these issues. Additionally, if the requirements or design goals change during the project, the initial design work may need to be repeated. As multiple stages are repeated, various stakeholders must reflect changes from other stages and repeat similar tasks, resulting in significant time and labor costs in SoC design.

### SUMMARY

The purpose of the present disclosure is to provide a clock element no-code design system and method that automatically generates register transfer level (RTL) code corresponding to individual clock elements constituting a clock management unit while considering the settings required in a clock design process of a system-on-chip (SoC) to address the above issues.

The present disclosure may be implemented in various ways, including an apparatus (system), a method, a computer program stored in a computer-readable medium, or a computer-readable medium having a computer program stored therein.

According to an embodiment of the present disclosure, a clock element no-code design system includes: a memory configured to store at least one instruction; a clock component storage configured to store clock component information defining an address and field values of a register of a clock instance generated based on a clock component; a hardware code logic storage configured to store a hardware code logic for generating hardware code based on a designed clock instance; and at least one processor configured to execute the at least one instruction stored in the memory. The at least one instruction includes instructions to: design a new clock instance by setting field values of a register defining a function of the new clock instance based on previously generated clock instance information and the clock component information, and generate hardware code by generating a clock module and a register module corresponding to the clock module based on the field values of the register of the designed new clock instance and the hardware code logic, and combining the clock module and the register module.

In some embodiments, the at least one instruction may further include instructions to: generate the new clock instance based on the previously generated clock instance information and the clock component information and store the new clock instance in a clock instance storage, determine field values of a base register for setting an essential function of a clock source corresponding to the new clock instance and store the field values in the clock instance storage, and determine a setting value of a field of an extension register defining an extended function of the new clock instance and store the setting value in the clock instance storage.

In some embodiments, the at least one instruction may further include instructions to: convert the designed new clock instance according to the hardware code logic to determine a port of the clock module, generate the register module including a port corresponding to the port of the clock module based on the field values of the register of the designed new clock instance, and connect the port of the clock module and the port of the register module and generate hardware code reflecting a design of the new clock instance.

In some embodiments, the clock component information may include an address range allocated to each clock component, an alignment size of each clock component, a base register offset size of each clock component, an extended register offset size of each clock component, and configuration field information for each clock component.

In some embodiments, the configuration field information for each clock component may include a field name, a bit position, a bit size, an access permission, and an initial value.

In some embodiments, a start address of the register of the new clock instance may be determined as a value obtained by adding a start address and an alignment size of a register of the previously generated clock instance.

In some embodiments, the clock component may be one of a PLL controller component, a clock divider component, a clock multiplexer component, and a clock gate component.

In some embodiments, the clock component may be the PLL controller component, and the field of the extension register of the new clock instance may include at least one of a power down field and a custom field.

In some embodiments, the clock component may be the clock divider component, and the field of the extension register of the new clock instance may include at least one of a power down field, a throttle field, and a custom field.

In some embodiments, the clock component may be the clock multiplexer component, and the field of the extension register of the new clock instance may include at least one of a throttle field and a custom field.

In some embodiments, the clock component may be the clock gate component, and the field of the extension register of the new clock instance may include at least one of a shortstop field, an early wakeup field, and a custom field.

According to an embodiment of the present disclosure, a clock element no-code design method is executed by at least one process in a computer system including a clock component storage in which clock component information defining an address and field values of a register of a clock instance generated based on a clock component is stored and a hardware code logic storage in which a hardware code logic for generating hardware code based on a designed clock instance is stored. The method includes a first step of designing a new clock instance by setting field values of a register defining a function of the new clock instance based on previously generated clock instance information and the clock component information; and a second step of generating the hardware code by generating a clock module and a register module corresponding to the clock module based on the field values of the register of the designed new clock instance and the hardware code logic, and combining the clock module and the register module.

In some embodiments, the first step may include: generating the new clock instance based on the previously generated clock instance information and the clock component information and storing the new clock instance in a clock instance storage; determining field values of a base register for setting an essential function of a clock source corresponding to the new clock instance and storing the field values in the clock instance storage; and determining a setting value of a field of an extension register defining an extended function of the new clock instance and storing the setting value in the clock instance storage.

In some embodiments, the second step may include: converting the designed new clock instance according to the hardware code logic to determine a port of the clock module; generating the register module including a port corresponding to the port of the clock module based on the field values of the register of the designed new clock instance; and connecting the port of the clock module and the port of the register module and generating hardware code reflecting a design of the new clock instance.

In some embodiments, the clock component information may include an address range allocated to each clock component, an alignment size of each clock component, a base register offset size of each clock component, an extended register offset size of each clock component, and configuration field information for each clock component.

In some embodiments, the configuration field information for each clock component may include a field name, a bit position, a bit size, an access permission, and an initial value.

In some embodiments, a start address of the register of the new clock instance may be determined as a value obtained by adding a start address and an alignment size of a register of the previously generated clock instance.

In some embodiments, the clock component may be one of a PLL controller component, a clock divider component, a clock multiplexer component, and a clock gate component.

In some embodiments, the clock component may be the PLL controller component, and the field of the extension register of the new clock instance may include at least one of a power down field and a custom field.

In some embodiments, the clock component may be the clock divider component, and the field of the extension register of the new clock instance may include at least one of a power down field, a throttle field, and a custom field.

In some embodiments, the clock component may be the clock multiplexer component, and the field of the extension register of the new clock instance may include at least one of a throttle field and a custom field.

In some embodiments, the clock component may be the clock gate component, and the field of the extension register of the new clock instance may include at least one of a shortstop field, an early wakeup field, and a custom field.

According to an embodiment of the present disclosure, a computer program stored in a computer-readable medium to execute the method on a computer is provided.

In various embodiments of the present disclosure, individual clock elements constituting a clock management unit may be designed while considering the settings required in the clock design process of a system-on-chip (SoC).

In various embodiments of the present disclosure, hardware code corresponding to individual clock elements constituting a clock management unit, i.e., register transfer level (RTL) code, may be automatically generated, thereby effectively improving the efficiency of the design process.

In various embodiments of the present disclosure, a user may derive hardware code (register transfer level (RTL) code) for individual clock elements constituting a clock management unit using a no-code approach, without requiring coding knowledge or expertise in clock processes.

In various embodiments of the present disclosure, since individual clock elements may be designed while considering the settings required throughout the clock design process, global optimization can be easily achieved.

The effects of the present disclosure are not limited to those mentioned above. Other effects not explicitly stated may be clearly understood by those skilled in the art from the description of the claims.

### BRIEF DESCRIPTION OF THE DRAWINGS

Embodiments of the present disclosure will be described with reference to the accompanying drawings, in which like reference numerals represent like elements, but are not limited thereto.

FIG. 1 is a block diagram illustrating a typical system-on-chip (SoC).

FIG. 2 is a detailed block diagram illustrating a clock management unit included in the SoC of FIG. 1.

FIG. 3 is a configuration diagram of a clock element no-code design system according to the present disclosure.

FIG. 4 is a diagram illustrating an example of a display screen of a clock element no-code design system according to the present disclosure.

FIG. 5 illustrates an example of address ranges of registers allocated to clock components.

FIG. 6 illustrates an example of the register address allocation for three clock divider instances.

FIG. 7 is an operational flowchart illustrating a clock element no-code design method according to the present disclosure.

FIG. 8 illustrates an exemplary computing device for performing the above-described method and/or embodiments.

### DETAILED DESCRIPTION OF EMBODIMENTS

Hereinafter, specific details for implementing the present disclosure will be described in detail with reference to the attached drawings. However, in the following description, a detailed description of known functions and configurations incorporated herein will be omitted when it may obscure the subject matter of the present disclosure.

The same reference numbers will be used in the drawings to refer to the same or like parts. In the description of embodiments below, redundant descriptions of identical or corresponding components may be omitted. However, even if the description of a component is omitted, it is not intended that such a component is not included in any embodiment.

The advantages and features of the embodiments disclosed in this specification, and methods for achieving the same will become clear with reference to the embodiments described below together with the attached drawings. However, the present disclosure is not limited to the embodiments disclosed below, but may be implemented in various different forms, and the embodiments are only provided to fully inform a person skilled in the art related to the present disclosure of the scope of the present disclosure.

The terms used in this specification will be briefly described, and the disclosed embodiments will be specifically described. The terms used in this specification are selected from the most widely used general terms in consideration of the functions in the present disclosure, but they may vary depending on the intention of engineers in the relevant field, precedents, or the emergence of new technologies, and in certain cases, there are terms arbitrarily selected by the applicant, and in this case, the meanings thereof will be described in detail in description of the relevant disclosure. Therefore, the terms used in this specification should be defined based on the meaning of the terms and the overall content of the present disclosure, not simply the names of the terms.

In this specification, singular expressions include plural expressions unless the context clearly specifies that they are singular. In addition, plural expressions include singular expressions unless the context clearly specifies that they are plural. When a part of the entire specification includes a certain component, this does not mean that other components are excluded, but that other components may be included, unless otherwise specifically stated.

In the present disclosure, the terms “comprise,” “comprising,” and the like may indicate the presence of features, steps, operations, elements, and/or components, but such terms do not exclude the addition of one or more other functions, steps, operations, elements, components, and/or combinations thereof.

In the present disclosure, when a specific component is referred to as being “coupled”, “combined”, “connected”, “associated”, or “reacted” with any other component, the specific component may be directly coupled, combined, connected, and/or associated or reacted with the other component, but is not limited thereto. For example, one or more intermediate components may exist between the specific component and the other component. In addition, “and/or” in the present disclosure may include each of one or more listed items or a combination of at least a part of one or more items.

In the present disclosure, the terms “first”, “second”, and the like are used to distinguish a specific component from other components, and the components described above are not limited by these terms. For example, a “first” component may be used to refer to an element having the same or similar form as a “second” component.

In various embodiments of the present disclosure, the term “clock components” refers to clock tools that may be utilized in clock management unit design, and the clock components may include a PLL controller component, a clock divider component, a clock multiplexer component, a clock gate component, and others. In embodiments of the present disclosure, clock components may be displayed as icons in a clock component window, and each clock component may include an icon, address ranges allocated to each clock component, alignment size of individual clock components, a base register offset size for each clock component, an extended register offset size for each clock component, configuration field information (field name, bit position, bit size, access permission, initial value, etc.) for each clock component, and the like.

In various embodiments of the present disclosure, a “clock instance” may refer to a clock component added to a design window by user operation, and the clock instance may be a clock component included in a clock management unit design. When the user drags and drops an arbitrary clock component icon from a clock component window to a design window area, a clock instance corresponding to the clock component may be created. When a clock instance is created, a base register and, optionally, an extended register for the clock instance may be automatically generated, and the field values constituting the base register and the optionally generated extended register may be preset or modified by user input. The clock management unit may include multiple clock instances for each type of clock component. A clock instance generated based on a PLL controller component is referred to as a PLL controller instance, a clock instance generated based on a clock divider component is referred to as a clock divider instance, a clock instance generated based on a clock multiplexer component is referred to as a clock multiplexer instance, and a clock instance generated based on a clock gate component is referred to as a clock gate instance. According to the present disclosure, when a clock instance is created, base register field values may be automatically assigned, and if the clock instance includes an extended register, extended register field values may also be automatically assigned. Some register field values may be modified according to user input, and hardware code may be generated based on the configured base register field values and extended register field values of the clock instance.

In various embodiments of the present disclosure, “clock element” may refer to a hardware-coded module based on a designed clock instance, which may configure a clock management unit.

In summary, a clock component is a building block for designing a clock management unit, a clock instance is a node included in a clock management unit design, and a clock element is a module that is implemented as hardware code based on a designed clock instance and may operate within a clock management unit.

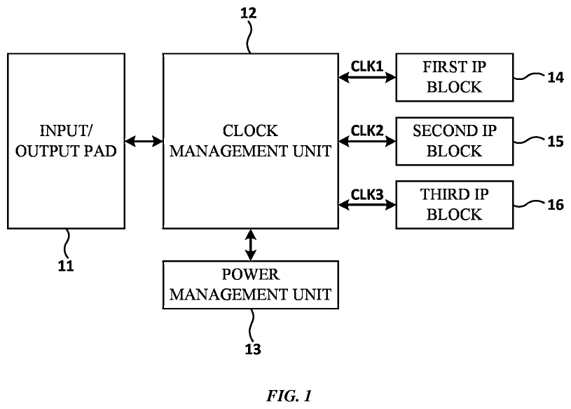

FIG. 1 is a block diagram illustrating a typical system on chip (SoC).

The SoC may include an input/output pad 11, a clock management unit (CMU) 12, a power management unit (PMU) 13, and one or more intellectual property (IP) blocks 14, 15, and 16. The clock management unit 12 may generate clock signals to be provided to the first through third IP blocks 14, 15, and 16. For example, the clock management unit 12 may generate first through third clock signals CLK1, CLK2, and CLK3. The clock management unit 12 may provide the first clock signal CLK1 to the first IP block 14, provide the second clock signal CLK2 to the second IP block 15, and provide the third clock signal CLK3 to the third IP block 16.

The first through third IP blocks 14, 15, and 16 are connected to a system bus and may communicate with each other through the system bus. Each of the first through third IP blocks 14, 15, and 16 may include a processor, a graphics processor, a memory controller, an input and output interface block, and others.

The power management unit 13 controls the power supplied to the first through third IP blocks 14 to 16. For example, when the SoC enters standby mode, the power management unit 13 may cut off the power provided to the first through third IP blocks 14 to 16, thereby reducing the power consumption of the SoC.

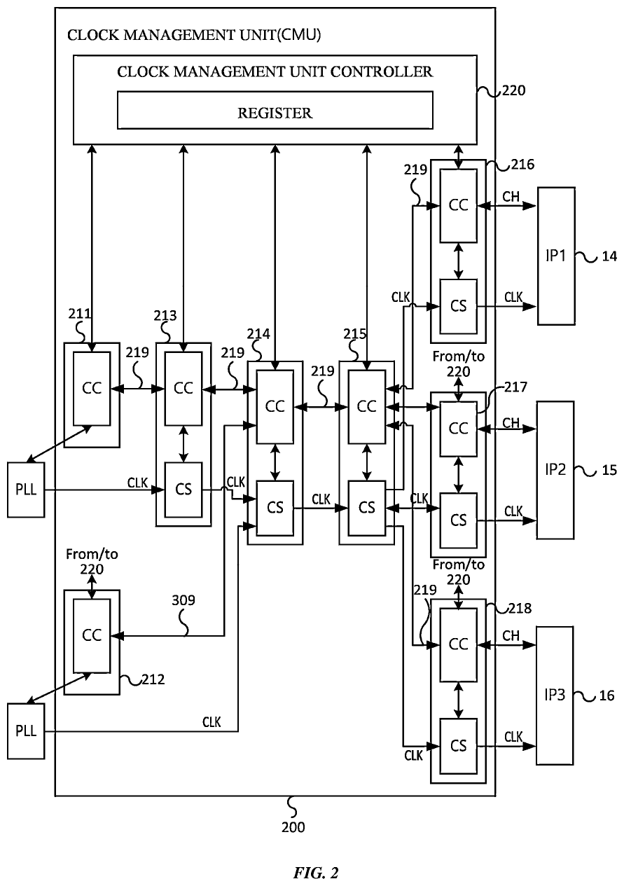

FIG. 2 is a detailed configuration block diagram of the clock management unit 12 and 200 included in the SoC of FIG. 1.

The clock management unit 200 may correspond to the clock management unit 12 of FIG. 1.

Referring to FIG. 2, the clock management unit 200 may include a plurality of clock elements 211, 212, 213, 214, 215, 216, 217, and 218 and a clock management unit CMU controller 220. The plurality of clock elements 211, 212, 213, 214, 215, 216, 217, and 218 generate clock signals CLK to be provided to the IP blocks 14, 15, and 16. The clock signals provided to the IP blocks 14, 15, and 16 may have different frequencies. The clock management unit controller 220 controls the clock elements 211, 212, 213, 214, 215, 216, 217, and 218 to ensure that a clock signal with the frequency required by the IP blocks 14, 15, and 16 is provided.

The clock elements may include phase locked loop (PLL) controllers 211 and 212, clock dividers 213 and 215, a clock multiplexer 214, and clock gates 216, 217, and 218.

Each clock element may include a clock source CS and a clock control circuit CC that controls the clock source CS. The clock source CS may include, for example, a multiplexing circuit, a divider circuit, and a gating circuit.

The PLL controllers 211 and 212 do not include a clock source and may control a PLL outside the clock management unit 200.

Each of the clock dividers 213 and 215 includes a devider circuit as a clock source CS, and the clock control circuit CC of each of the clock dividers 213 and 215 controls the devider circuit. The divider circuit divides an input clock signal and outputs it, and the clock control circuit CC may control the division ratio of the devider circuit.

The clock multiplexer 214 includes a multiplexing circuit as a clock source CS, and the clock control circuit CC of the clock multiplexer 214 controls the multiplexing circuit. The multiplexing circuit selectively outputs one of multiple input clock signals, and the clock control circuit CC may control which input clock signal is selected and output by the multiplexing circuit.

Each of the clock gates 216, 217, and 218 includes a gating circuit as a clock source CS, and the clock control circuit CC of each clock gate 216, 217, and 218 controls the gating circuit. The gating circuit enables a clock signal only when operation is required and blocks the clock signal otherwise, pausing the operation of the circuit and thereby preventing unnecessary clock signals. The clock control circuit CC may control the gating circuit to stop or enable a clock signal.

The clock element 211 is a parent of clock element 213, and clock element 213 is a child of clock element 211 and a parent of clock element 214. Clock element 214 is a child of two clock elements 212 and 213 and a parent of clock element 215. Clock element 215 is a child of clock element 214 and a parent of three clock elements 216, 217, and 218. Meanwhile, clock elements 211 and 212, which include a PLL controller, are root clock elements, and clock elements 216, 217, and 218, which are located close to the IP blocks 14, 15, and 16 and include gating circuits, are leaf clock elements.

Such a parent-child relationship may be established between clock control circuits CC and between clock sources CS according to the parent-child relationship between the clock elements 211, 212, 213, 214, 215, 216, 217, and 218. A signal line 219 connects between the clock control circuits CC such that the two clock control circuits CC may communicate through the signal line 219. A clock signal CLK may be transferred from a parent clock source CS to a child clock source CS.

The clock management unit controller 220 includes a register, and information necessary to control and configure the operation of the clock management unit 200 is recorded in the register as a register transfer level (RTL) code. In addition, the RTL code describing the operation of the clock control circuit of each clock element is written in the register of the clock management unit controller 220, and this RTL code may be implemented as actual clock management unit hardware using a hardware design tool. In the present disclosure, RTL code and hardware code may be used interchangeably.

Therefore, to configure the clock management unit, RTL code for each clock element needs to be generated, and RTL code describing the operation of each clock element needs to be generated and stored in the register of the clock management unit controller. In the past, developers manually generated hardware code using Verilog code based on clock diagram drawing results.

The present disclosure proposes a clock element no-code design system and method that allow various operational characteristics of a clock element to be set based on a graphical user interface (GUI) and derive register transfer level (RTL) code corresponding to the clock element using a no-code approach based on the set operational characteristics.

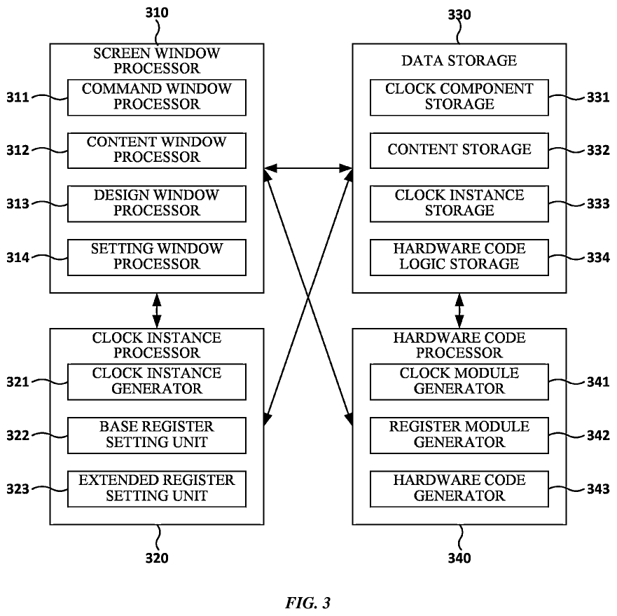

FIG. 3 is a configuration diagram of the clock element no-code design system according to the present disclosure. The clock element no-code design system according to the present disclosure may be implemented as a computer system.

The clock element no-code design system according to the present disclosure may include a screen window processor 310 that detects user input and outputs the processing result on a display screen, a clock instance processor 320 that generates a clock instance based on clock component information and designs the clock instance by setting field values of a base register that defines the basic functions of the clock instance, a data storage 330 that stores hardware code logic for generating hardware code based on clock component information, designed clock instance information, and the designed clock instance, and a hardware code processor 340 that generates a clock element based on designed clock instance information, generates a register module corresponding to the clock element, and produces hardware code by combining the clock element and the register module. The clock instance processor 320 may design a clock instance by setting extended register field values that define the extended functions of the clock instance.

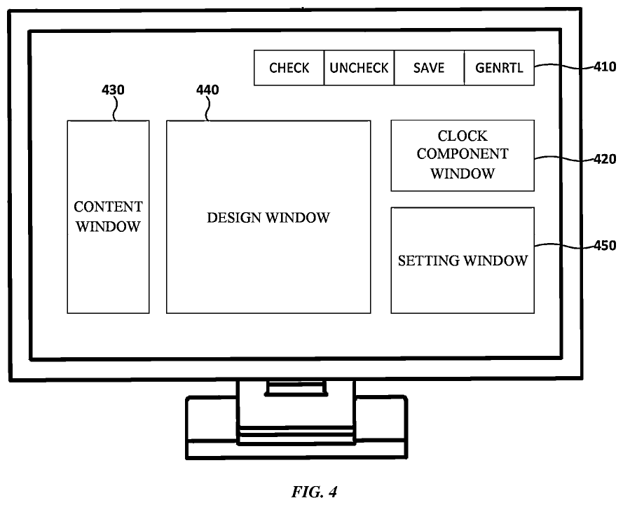

FIG. 4 is a diagram illustrating an example of a display screen of the clock element no-code design system according to the present disclosure.

The display screen of the clock element no-code design system according to the present disclosure may include a command window 410 for receiving user commands, a clock component window 420 displaying clock component icons, a content window 430 that provides an environment for adding, deleting, and modifying a list of clock management units under design and hierarchically displays a list of clock instances constituting each clock management unit under design along with the base register information of each clock instance, a design window 440 that displays a clock diagram of the clock management unit under design and provides an environment for adding, deleting, and modifying clock instances constituting the clock management unit under design, and a setting window 450 that provides an environment for modifying the settings of a clock instance selected in the design window 440. The content window 430 may further hierarchically display extended register information of each clock instance.

The command window 410 may include a CHECK button for receiving a check command to detect errors in the clock diagram of the clock management unit under design, the setting values of clock instances constituting the clock management unit under design, and the connections between parent and child clock instances; an UNCHECK button for receiving a command to deactivate a check result; a SAVE button for receiving a save command for the clock diagram displayed in the design window 440; and a GENRTL button for receiving a hardware code generation command for the clock diagram displayed in the design window 440.

The clock component window 420 may display icons representing a list of clock components that can be utilized in the design of the clock management unit. Clock components include a PLL controller component, a clock divider component, a clock multiplexer component, and a clock gate component, and the clock component window 420 may further display a label component. Here, a label component is a component inserted into the input and output between any two clock components for partial design work when designing a complex clock diagram. When hardware code is generated, the label component may be ignored, and the two clock components may be coded to be directly connected.

The content window 430 displays a list of clock management units under design and provides an environment for adding, deleting, and modifying clock management units under design. In addition, under each clock management unit list, the content window 430 may display a list of clock instances constituting the corresponding clock management unit under design and hierarchically display the base register information of each clock instance. Optionally, the content window 430 may further display extended register information of each clock instance.

The design window 440 displays a clock diagram of the clock management unit under design and provides an environment for adding, deleting, and modifying clock instances that constitute the clock management unit under design. When the user drags and drops any clock component from the clock component window 420 to the design window 440, a clock instance may be created in the clock management unit under design. When a clock instance is created, a new clock instance list and the base register information of the new clock instance may be hierarchically added to the content window 430. Optionally, the extended register information of the new clock instance may also be added.

The setting window 450 displays an environment for modifying the setting values of the clock instance selected in the design window 440.

The screen window processor 310 may include a command window processor 311 that displays buttons for receiving user commands on the command window 410, detects inputs from each button on the command window 410, and performs an operation corresponding to the input button; a content window processor 312 that hierarchically displays a list of clock management units under design, along with a list of clock instances and register information included in each clock management unit under design, on the content window 430, detects user input in the content window 430, and performs an operation corresponding to the user input; a design window processor 313 that displays the clock diagram of a clock management unit under design selected by the user on the design window 440, detects user input in the design window 440, and performs an operation corresponding to the user input; and a setting window processor 314 that displays the configuration information of a clock instance selected by the user on the setting window 450, detects user input in the setting window 450, and performs an operation corresponding to the user input.

When the CHECK button is selected, the command window processor 311 performs a check operation to detect errors in the clock diagram of the clock management unit under design, the setting values of the clock instances constituting the clock management unit under design, and the connections between parent and child clock instances, and highlights the parts where errors have occurred. When the UNCHECK button is selected, the command window processor 311 restores the error indications in the clock diagram of the clock management unit under design to their original state and updates the display accordingly. When the SAVE button is selected, the command window processor 311 saves the clock-related design details of the clock management unit under design displayed in the design window 440 to the content data storage 330. When the GENRTL button is selected, the command window processor 311 generates hardware code for the clock diagram of the clock management unit under design displayed in the design window 440.

The content window processor 312 provides an environment for adding, deleting, and modifying a list of clock management units under design and a list of clock instances included in each clock management unit under design. The content window processor 312 hierarchically displays a clock instance list under each clock management unit under design, along with the base register information of each clock instance and, optionally, the extended register information. The user may add, delete, or rename a clock management unit under design in the content window, and in response to user input, the list of clock management units under design may be added, deleted, or renamed in the content storage 332. When the user renames a clock management unit under design, the content window processor 312 ensures that not only the name of the clock management unit under design but also the names of its clock instances, as well as the base register names and extended register names of the clock instances, are changed simultaneously.

The design window processor 313 ensures that the clock diagram of the clock management unit under design is displayed in the design window 440 and provides an environment for adding, deleting, and modifying clock instances that constitute the clock management unit under design. When the user adds an arbitrary clock component from the clock component window 420 to the design window 440, the design window processor 313 detects this action and initiates the clock instance addition process.

The setting window processor 314 ensures that the configuration information of the clock instance selected by the user is displayed in the setting window 450, detects user input in the setting window 450, and performs an operation corresponding to the user input. The data storage 330 may include a clock component storage 331 that stores clock component information, a content storage 332 that stores a list of clock management units under design, a list of clock instances for each clock management unit under design, and a list of registers corresponding to the clock instances, a clock instance storage 333 that stores clock instance information and register information of clock instances, and a hardware code logic storage 334 that stores hardware code logic for generating hardware code based on designed clock instance information and register information.

The list of registers corresponding to clock instances may include a base register list and an extended register list.

The clock component information stored in the clock component storage 331 may include the address range allocated to each clock component, the alignment size of each clock component, the base register offset size for each clock component, the extended register offset size for each clock component, and configuration field information (field name, bit position, bit size, access permission, initial value, etc.) for each clock component. The clock component information defines the register address and field values of a clock instance generated based on the corresponding clock component. The maximum number of clock instances for each clock component may be calculated using the address range allocated to each clock component and its alignment size. Clock components may include a PLL controller component, a clock divider component, a clock multiplexer component, and a clock gate component.

The address range allocated to each clock component, the alignment size of each clock component, the base register offset size for each clock component, the extended register offset size for each clock component, and the configuration field information for each clock component may all be determined differently.

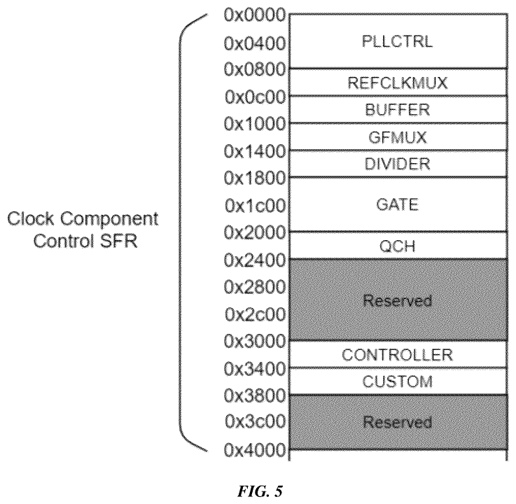

FIG. 5 illustrates an example of register address ranges allocated to clock components. For example, an address range of 0x0000 to 0x0800 may be allocated to the PLL controller component, an address range of 0x1400 to 0x1800 may be allocated to the clock divider component, an address range of 0x1000 to 0x1400 may be allocated to the clock multiplexer component, and an address range of 0x1800 to 0x2000 may be allocated to the clock gate component.

The clock management unit may include multiple clock instances for each type of clock component. For example, it may include three clock divider instances.

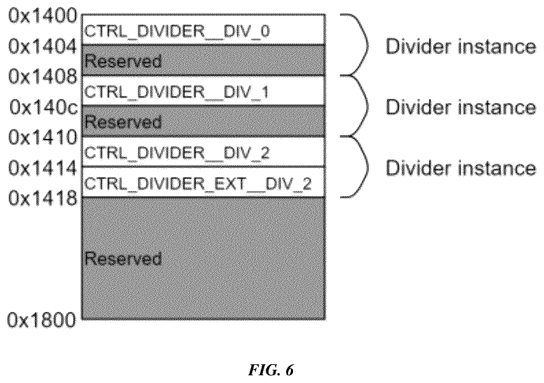

FIG. 6 illustrates an example of register address allocation for three clock divider instances.

The addresses of the three clock divider instances are allocated within the address range 0x1400 to 0x1800 assigned to each clock component. The register address of the first clock divider instance DIV_0 may be allocated as the start address 0x1400 of the address range assigned to the clock divider component. The register address of the second clock divider instance DIV_1 may be 0x1408, obtained by adding the start address of the first clock divider instance and its alignment size 0x8. The register address of the third clock divider instance may be 0x1414, obtained by adding the start address of the second clock divider instance and its alignment size. The first and second clock divider instances include only base registers, while the third clock divider instance may include both a base register and an extended register. Base register setting values of the clock divider instances are written from the clock divider instance start addresses up to the base register offset sizes, and extended register setting values are written to the remaining space.

The clock component storage 331 stores configuration field information (field name, bit position, bit size, access permission, initial value, etc.) for each individual clock component. This configuration field information may vary depending on the type of each clock component. Here, the bit position refers to the start address of the corresponding field among the addresses allocated to an individual clock instance, the bit size indicates the range of the field, the access permission specifies whether write access is allowed (read-only or read-write), and the initial value represents the initial setting value.

The PLL controller component may include a SELECT field, a BUSY field, and a DEBUG (DBG_INFO) field as base register information and may include a POWER-DOWN (PWRDOWN) field and a CUSTOM field as extended register information. The field name, bit position, bit size, access permission, and initial value of each field may be configured. Here, the SELECT field is used to select a PLL type, the BUSY field is used to monitor whether the clock element is operating, and the DEBUG field stores debugging information.

The clock multiplexer component includes a SELECT field, a BUSY field, and a DEBUG (DBG_INFO) field as base register information and may include a THROTTLE field and a CUSTOM field as extended register information. The field name, bit position, bit size, access permission, and initial value of each field are configured. Here, the SELECT field is used to select the number of multiplexer inputs, the BUSY field is used to monitor whether the clock element is operating, and the DEBUG field stores debugging information.

The clock divider component includes a division ratio (DIVRATIO) field, a BUSY field, and a DEBUG (DBG_INFO) field as base register information and may include a POWER-DOWN (PWRDOWN) field, a THROTTLE field, and a CUSTOM field as extended register information. The field name, bit position, bit size, access permission, and initial value of each field are configured. The division ratio field is used to set the division ratio of the clock divider, the BUSY field is used to monitor whether the clock element is operating, and the DEBUG field stores debugging information.

The clock gate component may include an ENABLE field, a BUSY field, and a DEBUG (DBG_INFO) field as base register information and may include a SHORTSTOP field, an EARLY WAKEUP (EWAKEUP) field, and a CUSTOM field as extended register information. The field name, bit position, bit size, access permission, and initial value of each field are configured. The BUSY field is used to monitor whether the clock element is operating, and the DEBUG field stores debugging information.

The POWER-DOWN (PWRDOWN) field determines whether to use a function that controls the relevant clock element while the power up/down sequence of any power domain is in operation. The PLL controller instance and the clock multiplexer instance support an operational feature that forces the output value to be overridden to 0 if the POWER-DOWN field is set to a specific field value, while the clock divider instance supports an operational feature that forces the output value to a low level if the POWER-DOWN field is set to a specific field value.

The THROTTLE field determines whether to lower the clock frequency momentarily to reduce temperature when the clock element's temperature exceeds a certain threshold. The clock multiplexer instance and the clock divider instance support an operational feature that forces the division ratio and output frequency to change when a throttle signal is input if the THROTTLE field is set to a specific field value.

The CUSTOM field determines whether to control the relevant clock element through separate custom hardware. The SHORTSTOP field supports an operational feature that stops several cycles before and after a transition where a signal changes from 0 to 1 or from 1 to 0.The SHORTSTOP field may be set in the clock gate instance. The EWAKEUP field receives a signal from outside the clock management unit to determine whether to enable auto clock gating of the clock element.

The clock instance storage 333 stores clock instance information and register information for each clock instance included in a clock management unit under design. The clock instance storage 333 may store the name of the clock management unit under design, the type of clock component of each clock instance, the start address of the corresponding clock instance, and the setting values of each register field. The setting values of each register field may be configured based on clock component information or may be adjusted according to user input.

The hardware code logic storage 334 stores hardware code logic for generating hardware code based on designed clock instance information and register information.

The clock instance processor 320 may include a clock instance generator 321 that generates a new clock instance based on information on a previously generated clock instance of the same clock component type and clock component information and stores it in the clock instance storage 333, a base register setting unit 322 that sets field values of a base register that define the basic functions of the new clock instance and stores them in the clock instance storage 333, and an extended register setting unit 323 that sets field values of an extended register that define the extended functions of the new clock instance and stores them in the clock instance storage 333.

The clock instance generator 321 may be executed to generate a new clock instance when the user adds any clock component from the clock component window 420 to the design window 440. The name of the new clock instance may include the name of the clock management unit under design that contains the new clock instance and information on the clock component type of the new clock instance. In addition, the address of the new clock instance may be set based on information from a previously generated clock instance of the same clock component type and clock component information. That is, the start address of the register of the new clock instance may be determined by adding the start address of the register of the previously generated clock instance to the alignment size of the clock component information, and the initial setting value of the register field may be determined based on the base register offset size, extended register offset size, and configuration field information of the clock component.

The base register setting unit 322 may display the field name, bit position, bit size, access permission, and initial values of the configuration fields included in the base register on the design window 440 or the setting window 450 and may modify them according to user input.

The base register configures the essential functions of the clock source of the clock element. That is, for the PLL controller instance, functions such as PLL type selection, clock element operation monitoring, and debugging may be set, and the corresponding register field values may be configured. For the clock multiplexer instance, functions such as multiplexer input selection, clock element operation monitoring, and debugging may be set, and the corresponding register field values may be configured. For the clock divider instance, functions such as division ratio configuration, clock element operation monitoring, and debugging may be set, and the corresponding register field values may be configured. For the clock gate instance, functions such as enable control, clock element operation monitoring, and debugging may be set, and the corresponding register field values may be configured.

The extended register setting unit 323 may display extended functions that can be configured for each clock component on the screen. When the user selects an extended function, the corresponding field of the extended register can be set. For the PLL controller instance, the POWER-DOWN (PWRDOWN) function and the CUSTOM function may be selected, and the setting values of the extended register field corresponding to the selected function may be configured. For the clock multiplexer instance, the THROTTLE function and the CUSTOM function may be selected, and the setting values of the extended register field corresponding to the selected function may be configured. For the clock divider instance, the POWER-DOWN (PWRDOWN) function, the THROTTLE function, and the CUSTOM function may be selected, and the setting values of the extended register field corresponding to the selected function may be configured. For the clock gate instance, the SHORTSTOP function, the EARLY WAKEUP (EWAKEUP) function, and the CUSTOM function may be selected, and the setting values of the extended register field corresponding to the selected function may be configured.

The hardware code processor 340 includes a clock module generator 341 that generates a clock module based on designed clock instance information, a register module generator 342 that generates a register module corresponding to the clock module, and a hardware code generator 343 that creates hardware code by combining the clock module and the register module.

The hardware code processor 340 may be executed when the GENRTL button in the command window 410 is selected. The user can select and execute the GENRTL button while a clock diagram of a clock management unit under design is displayed in the design window 440. Before executing the GENRTL button, the user can also verify in advance whether there are any errors in the clock diagram by executing the CHECK button.

The clock module generator 341 converts designed clock instance information in accordance with the hardware code logic stored in the hardware code logic storage 334 to generate a clock module. The port type of the clock module and the hierarchical structure of the hardware module may be determined based on the configuration of the designed clock instance.

The register module generator 342 generates a register module according to the hardware code logic based on the register field values of the designed clock instance, and the ports of the register module corresponding to the ports of the clock module may be created. For example, a clock divider module may include a division ratio port, a busy port, and a debug port, and the corresponding division ratio port, busy port, and debug port may be generated for the register module related to the clock divider module.

The hardware code generator 343 automatically connects the ports of the clock module and the corresponding ports of the register module according to the hardware code logic and generates hardware code (RTL code) reflecting the setting values of the clock instance.

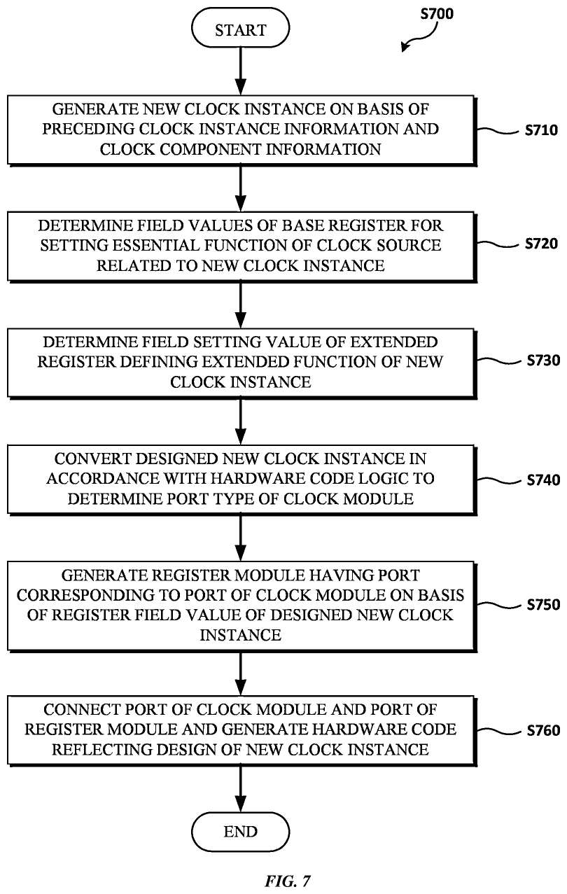

FIG. 7 is an operation flowchart illustrating a clock element no-code design method according to the present disclosure. The clock element no-code design method according to the present disclosure may be executed by a processor of a computer system.

The computer system includes a clock component storage that stores clock component information for defining the register addresses and field values of clock instances generated based on clock components, and a hardware code logic storage that stores hardware code logic for generating a designed clock instance as hardware code.

The processor designs a new clock instance by setting the field values of registers that define the functions of the new clock instance based on information from previously generated clock instances and the clock component information.

The process of designing a new clock instance by the processor is described in detail. The processor generates a new clock instance based on information from previously generated clock instances and the clock component information and stores it in the clock instance storage (S710), determines the field values of a base register for configuring the essential functions of a clock source corresponding to the new clock instance and stores them in the clock instance storage (S720), and determines the setting values of the fields of an extended register that defines the extended functions of the new clock instance and stores them in the clock instance storage (S730).

Next, the processor generates a clock module and a register module corresponding to the clock module based on the field values of the register of the designed new clock instance and the hardware code logic and generates hardware code by combining the clock module and the register module.

The process of generating hardware code by the processor is described in detail. The processor converts the designed new clock instance according to the hardware code logic to determine the port type of the clock module (S740), generates a register module that includes ports corresponding to the ports of the clock module based on the register field values of the designed new clock instance (S750), connects the ports of the clock module and the ports of the register module, and generates hardware code reflecting the design of the new clock instance (S760).

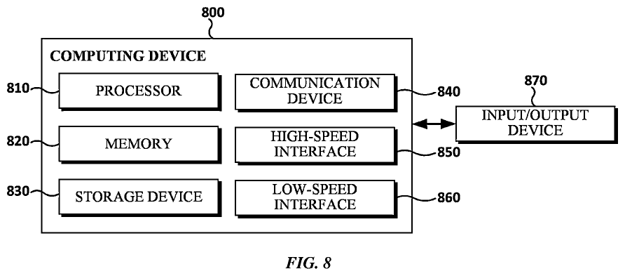

FIG. 8 illustrates an exemplary computing device 800 for performing the methods and/or embodiments described above. According to one embodiment, the computing device 800 may be implemented using hardware and/or software configured to interact with a user. Here, the computing device 800 may include, but is not limited to, a laptop, a desktop, a workstation, a personal digital assistant, a server, a blade server, a mainframe, and the like. The components of the computing device 800, their connections, and their functions are intended to be exemplary and are not intended to limit the implementations of the present disclosure described and/or claimed herein.

The computing device 800 includes a processor 810, a memory 820, a storage device 830, a communication device 840, a high-speed interface 850 connected to the memory 820 and a high-speed expansion port, and a low-speed interface 860 connected to a low-speed bus and the storage device. The components 810, 820, 830, 840, 850, and 860 may be interconnected using various buses and may be mounted on the same mainboard or connected in another suitable manner. The processor 810 may be configured to process instructions of a computer program by performing basic arithmetic, logic, and input/output operations. For example, the processor 810 may process instructions stored in the memory 820 and the storage device 830 and/or instructions executed within the computing device 800 to display graphical information on an external input/output device 870, such as a display device connected to the high-speed interface 850.

The communication device 840 may provide a configuration or function that enables the input/output device 870 and the computing device 800 to communicate with each other through a network and may also provide a configuration or function that supports communication between the input/output device 870 and/or the computing device 800 and other external devices. For example, a request or data generated by the processor of an external device according to a given program code may be transmitted to the computing device 800 through a network under the control of the communication device 840. Conversely, a control signal or command issued under the control of the processor 810 of the computing device 800 may be transmitted to another external device through the communication device 840 and the network. Although the computing device 800 is illustrated in FIG. 8 as including a single processor 810, a single memory 820, and the like, the present disclosure is not limited thereto, and the computing device 800 may be implemented using multiple memories, multiple processors, and/or multiple buses. Additionally, although FIG. 8 describes a single computing device 800, the present disclosure is not limited thereto, and multiple computing devices may interact and perform the operations necessary to execute the described method.

The memory 820 may store information within the computing device 800. In one embodiment, the memory 820 may be configured as a volatile memory unit or multiple memory units. Additionally or alternatively, the memory 820 may be configured as a non-volatile memory unit or multiple memory units. Furthermore, the memory 820 may be configured as a different type of computer-readable medium, such as a magnetic disk or an optical disk. Additionally, the memory 820 may store an operating system and at least one program code and/or instruction.

The storage device 830 may be one or more mass storage devices for storing data for the computing device 800. For example, the storage device 830 may be a computer-readable medium that includes a magnetic disk such as a hard disk or a removable disk, an optical disk, a semiconductor memory device such as an erasable programmable read-only memory (EPROM), an electrically erasable PROM (EEPROM), or a flash memory device, as well as a CD-ROM and a DVD-ROM disk, or may be configured to include such a computer-readable medium. Additionally, a computer program may be physically implemented in such a computer-readable medium.

The high-speed interface 850 and the low-speed interface 860 may serve as means for interacting with the input/output device 870. For example, an input device may include devices such as a camera with an audio sensor and/or an image sensor, a keyboard, a microphone, and a mouse, while an output device may include devices such as a display, a speaker, and a haptic feedback device. In another example, the high-speed interface 850 and the low-speed interface 860 may serve as means for interfacing with a device that integrates both input and output functions, such as a touchscreen.

In one embodiment, the high-speed interface 850 may manage bandwidth-intensive operations for the computing device 800, whereas the low-speed interface 860 may manage operations that are less bandwidth-intensive than those of the high-speed interface 850, but such a functional allocation is merely exemplary. In one embodiment, the high-speed interface 850 may be connected to the memory 820, the input/output devices 870, and high-speed expansion ports that accommodate various expansion cards (not shown). Additionally, the low-speed interface 860 may be connected to the storage device 830 and a low-speed expansion port. Furthermore, the low-speed expansion port, which may include various communication ports (e.g., USB, Bluetooth, Ethernet, and wireless Ethernet), may be connected to one or more input/output devices 870, such as a keyboard, a pointing device, or a scanner, or to networking devices such as a router or a switch via a network adapter.

The computing device 800 may be implemented in multiple different forms. For example, it may be implemented as a standard server or as a group of such standard servers. Additionally or alternatively, the computing device 800 may be implemented as part of a rack server system or as a personal computer, such as a laptop. In this case, components of the computing device 800 may be integrated with other components within any mobile device (not shown). The computing device 800 may include one or more other computing devices or may be configured to communicate with one or more other computing devices.

Although the input/output device 870 is illustrated in FIG. 8 as not being included in the computing device 800, this is not limiting, and the input/output device 870 may be configured as a single integrated device with the computing device 800. Additionally, although the high-speed interface 850 and/or the low-speed interface 860 are illustrated in FIG. 8 as components separate from the processor 810, this is not limiting, and they may be configured to be included in the processor 810.

The above-described method and/or various embodiments may be realized by digital electronic circuits, computer hardware, firmware, software, and/or a combination thereof. Various embodiments of the present disclosure may be implemented by a data processing device, for example, one or more programmable processors and/or one or more computing devices, or as a computer-readable medium and/or a computer program stored on a computer-readable medium. The computer program described above may be written in any programming language, including compiled or interpreted languages, and may be distributed in any form, such as a standalone program, a module, or a subroutine. The computer program may be distributed through a single computing device, a plurality of computing devices connected through the same network, and/or a plurality of computing devices distributed to be connected through a plurality of different networks.

The above-described method and/or various embodiments may be performed by one or more processors configured to execute one or more computer programs that process, store and/or manage any function and the like by operating based on input data or generating output data. For example, the method and/or various embodiments of the present disclosure may be performed by a special purpose logic circuit such as a field programmable gate array (FPGA) or an application specific integrated circuit (ASIC), and a device and/or a system for performing the method and/or embodiments of the present disclosure may be implemented as special purpose logic circuits such as an FPGA or an ASIC.

The one or more processors executing a computer program may include one or more processors of a general purpose or special purpose microprocessor and/or any kind of digital computing device. The processor may receive instructions and/or data from each of a read-only memory and a random access memory, or may receive instructions and/or data from the read-only memory and the random access memory. In the present disclosure, components of a computing device performing the method and/or embodiments may include one or more processors for executing instructions, and one or more memories for storing instructions and/or data.

In one embodiment, the computing device may transmit/receive data to/from one or more mass storage devices for storing data. For example, the computing device may receive data from a magnetic disc or an optical disc and/or transmit data to the magnetic disc or the optical disc. A computer-readable medium suitable for storing instructions and/or data associated with a computer program may include, but is not limited to, any form of non-volatile memory, including semiconductor memory devices such as an erasable programmable read-only memory (EPROM), an electrically erasable PROM (EEPROM), and a flash memory device. For example, the computer-readable medium may include a magnetic disc, such as an internal hard disk or a removable disk, a photomagnetic disc, a CD-ROM, and a DVD-ROM disk.

To provide interaction with a user, the computing device may include, but is not limited to, a display device (e.g., a cathode ray tube (CRT), a liquid crystal display (LCD), or the like) for providing or displaying information to the user, and a pointing device (e.g., a keyboard, a mouse, a trackball, or the like) for enabling the user to provide input and/or commands to the computing device. That is, the computing device may further include any other types of devices for providing interaction with the user. For example, the computing device may provide any form of sensory feedback to the user, including visual feedback, auditory feedback, and/or tactile feedback, for interacting with the user. In this regard, the user may provide input to the computing device through various gestures, such as vision, voice, and motion.

In the present disclosure, various embodiments may be implemented in a computing device including a back-end component (e.g., a data server), a middleware component (e.g., an application server), and/or a front-end component. In this case, the components may be interconnected by any form or medium of digital data communication, such as a communication network. In one embodiment, the communication network may include a wired network such as Ethernet, a power line communication), a telephone line communication device, and RS-serial communication, a wireless network such as a mobile communication network, a wireless LAN (WLAN), Wi-Fi, Bluetooth, and ZigBee, or a combination thereof. For example, the communication network may include a local area network (LAN), a wide area network (WAN), or the like.

The computing device based on the exemplary embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include, but is not limited to, a personal digital assistant (PDA), a tablet PC, a game console, a wearable device, an Internet-of-Things (IoT) device, a virtual reality (VR) device, an augmented reality (AR) device, and the like. The computing device may further include other types of devices configured to interact with a user. Furthermore, the computing device may include a portable communication device (e.g., a mobile phone, a smartphone, a wireless cellular phone, and the like) suitable for wireless communication over a network, such as a mobile communication network. The computing device may be configured to wirelessly communicate with a network server using wireless communication technologies such as Radio Frequency (RF), Microwave Frequency (MWF), and/or Infrared Ray Frequency (IRF) and/or protocols.

Various embodiments including specific structural and functional details in the present disclosure are exemplary. Therefore, the embodiments of the present disclosure are not limited to those described above, and may be implemented in various other forms. In addition, the terms used in the present disclosure are intended to describe some embodiments and are not to be construed as limiting the embodiments. For example, singular words and the above may be construed to include plural forms unless the context clearly indicates otherwise.

In the present disclosure, unless otherwise defined, all terms used in this specification, including technical or scientific terms, have the same meaning as commonly understood by a person skilled in the art to which such concepts belong. In addition, commonly used terms, such as terms defined in the dictionary, should be interpreted as having a meaning consistent with the meaning in the context of the relevant technology.

Although the present disclosure has been described in connection with some embodiments herein, various modifications and changes may be made without departing from the scope of the present disclosure as understood by a person skilled in the art to which the present disclosure belongs. In addition, such modifications and changes should be considered to fall within the scope of the claims appended hereto.

What is claimed is:

1. A clock element no-code design system, the system for designing a clock element using a no-code approach, the system comprising:
a memory configured to store at least one instruction;
a clock component storage configured to store clock component information defining an address and field values of a register of a clock instance generated based on a clock component;
a hardware code logic storage configured to store a hardware code logic for generating hardware code based on a designed clock instance; and
at least one processor configured to execute the at least one instruction stored in the memory,
wherein the at least one instruction comprises instructions to:
design a new clock instance by setting field values of a register defining a function of the new clock instance based on previously generated clock instance information and the clock component information, and
generate hardware code by generating a clock module and a register module corresponding to the clock module based on the field values of the register of the designed new clock instance and the hardware code logic, and combining the clock module and the register module.

2. The clock element no-code design system of claim 1, wherein the at least one instruction further comprises instructions to:
generate the new clock instance based on the previously generated clock instance information and the clock component information and store the new clock instance in a clock instance storage,
determine field values of a base register for setting an essential function of a clock source corresponding to the new clock instance and store the field values in the clock instance storage, and
determine a setting value of a field of an extension register defining an extended function of the new clock instance and store the setting value in the clock instance storage.

3. The clock element no-code design system of claim 1, wherein the at least one instruction further comprises instructions to:
convert the designed new clock instance according to the hardware code logic to determine a port of the clock module,
generate the register module including a port corresponding to the port of the clock module based on the field values of the register of the designed new clock instance, and
connect the port of the clock module and the port of the register module and generate hardware code reflecting a design of the new clock instance.

4. The clock element no-code design system of claim 1, wherein the clock component information comprises an address range allocated to each clock component, an alignment size of each clock component, a base register offset size of each clock component, an extended register offset size of each clock component, and configuration field information for each clock component.

5. The clock element no-code design system of claim 4, wherein the configuration field information for each clock component comprises a field name, a bit position, a bit size, an access permission, and an initial value.

6. The clock element no-code design system of claim 4, wherein a start address of the register of the new clock instance is determined as a value obtained by adding a start address and an alignment size of a register of the previously generated clock instance.

7. The clock element no-code design system of claim 2, wherein the clock component is one of a PLL controller component, a clock divider component, a clock multiplexer component, and a clock gate component.

8. The clock element no-code design system of claim 7, wherein the clock component is the PLL controller component, and
the field of the extension register of the new clock instance comprises at least one of a power down field and a custom field.

9. The clock element no-code design system of claim 7, wherein the clock component is the clock divider component, and
the field of the extension register of the new clock instance comprises at least one of a power down field, a throttle field, and a custom field.

10. The clock element no-code design system of claim 7, wherein the clock component is the clock multiplexer component, and
the field of the extension register of the new clock instance comprises at least one of a throttle field and a custom field.

11. The clock element no-code design system of claim 7, wherein the clock component is the clock gate component, and
the field of the extension register of the new clock instance comprises at least one of a shortstop field, an early wakeup field, and a custom field.

12. A clock element no-code design method, the method for designing a clock element using a no-code approach, the method executed by at least one process in a computer system comprising a clock component storage in which clock component information defining an address and field values of a register of a clock instance generated based on a clock component is stored and a hardware code logic storage in which a hardware code logic for generating hardware code based on a designed clock instance is stored, the method comprising:
a first step of designing a new clock instance by setting field values of a register defining a function of the new clock instance based on previously generated clock instance information and the clock component information; and
a second step of generating hardware code by generating a clock module and a register module corresponding to the clock module based on the field values of the register of the designed new clock instance and the hardware code logic, and combining the clock module and the register module.

13. The clock element no-code design method of claim 12, wherein the first step comprises:
generating the new clock instance based on the previously generated clock instance information and the clock component information and storing the new clock instance in a clock instance storage,
determining field values of a base register for setting an essential function of a clock source corresponding to the new clock instance and storing the field values in the clock instance storage, and
determining a setting value of a field of an extension register defining an extended function of the new clock instance and storing the setting value in the clock instance storage.

14. The clock element no-code design method of claim 12, wherein the second step comprises:
converting the designed new clock instance according to the hardware code logic to determine a port of the clock module,
generating the register module including a port corresponding to the port of the clock module based on the field values of the register of the designed new clock instance, and
connecting the port of the clock module and the port of the register module and generating hardware code reflecting a design of the new clock instance.

15. The clock element no-code design method of claim 12, wherein the clock component information comprises an address range allocated to each clock component, an alignment size of each clock component, a base register offset size of each clock component, an extended register offset size of each clock component, and configuration field information for each clock component.

16. The clock element no-code design method of claim 15, wherein the configuration field information for each clock component comprises a field name, a bit position, a bit size, an access permission, and an initial value.

17. The clock element no-code design method of claim 15, wherein a start address of the register of the new clock instance is determined as a value obtained by adding a start address and an alignment size of a register of the previously generated clock instance.

18. The clock element no-code design method of claim 13, wherein the clock component is one of a PLL controller component, a clock divider component, a clock multiplexer component, and a clock gate component.

19. The clock element no-code design method of claim 18, wherein the field of the extension register of the new clock instance comprises at least one of a power down field, a throttle field, a shortstop field, an early wakeup field, and a custom field.

20. A computer program, stored in a computer-readable medium, for executing the method according to claim 12 on a computer.
